(19) United States
(12) Patent Application Publication
(10) Pub. No.: US 2013/0225076 A1
(43) Pub. Date: Aug. 29, 2013

(54) RECHARGE OF AN NFC DEVICE

(71) Applicant: STMicroelectronics Rousset SAS, (US)

(72) Inventors: Pierre Rizzo, Trets (FR); Alexandre Charles, Auriol (FR); Alexandre Malherbe, Trets (FR); Nathalie Vallespin, Greasque (FR)

(73) Assignee: STMICROELECTRONICS ROUSSET SAS, Rousset (FR)

(21) Appl. No.: 13/774,679

(22) Filed: Feb. 22, 2013

(30) Foreign Application Priority Data
Feb. 24, 2012 (FR) 1251726

(51) Int. Cl. H04B 5/00

(52) U.S. Cl. CPC H04B 5/0037
USPC 455/41.1

(57) ABSTRACT

A mobile device including: a battery; an element for charging the battery; a near-field communication circuit; and a connection between the near-field communication circuit and the battery charge element.

### BACKGROUND

1. Technical Field

The present disclosure generally relates to electronic devices and mobile communication equipment and, more specifically, to devices equipped with a near field communication (NFC) module.

The present disclosure more specifically applies to devices comprising a near-field communication mechanism and a rechargeable power supply battery.

2. Description of the Related Art

Many devices are now provided with near-field communication functions. The most common are mobile telecommunication devices (cell phones), which are more and more often equipped with a near-field communication interface, generally called NFC router, providing additional functions to the phone. NFC routers enable a mobile device to operate either in card mode, the device then having the functions of a contactless communication card, or in reader mode, the mobile device then having the functions of a contactless card read and/or write terminal.

In card mode, the mobile communication device is capable of operating by being powered by the field radiated by a terminal with which it communicates and without using the power of the device battery. This especially enables to provide a cell phone with contactless card functions even while the phone is off or fully discharged.

In reader mode, the device uses its rechargeable battery to emit a high-frequency field capable of being detected by another device operating in card mode. The battery of the device is generally charged by means of a device external to the cell phone, such as a transformer connected to the electric distribution network, a direct current generator, a solar panel, etc.

### BRIEF SUMMARY

An embodiment facilitates addressing all or part of the disadvantages of devices combining a battery and a near-field communication interface.

An embodiment improves the power management in such a device.

In an embodiment, a mobile device comprises:

a battery;

an element for charging the battery;

a near-field communication circuit; and

a connection between the near-field communication circuit and the battery charge element.

According to an embodiment, the near-field communication circuit integrates a rectifying bridge having an output directly connected to a terminal of said circuit.

According to an embodiment, the near-field communication circuit is connected to said element via a switch.

According to an embodiment, said switch is controlled by the near-field communication circuit.

According to an embodiment, the near-field communication circuit is connected to said element via a resistive element.

According to an embodiment, the resistive element has a variable value, controllable by the near-field communication circuit.

An embodiment provides a method for controlling such a device, wherein the charge of the battery is started in a near-field communication with a terminal.

According to an embodiment, the battery charge is controlled outside periods of transaction in the context of the radio frequency communication.

In an embodiment, an integrated circuit comprises: near-field communication circuitry configured to process near-field communication signals; a rectifier configured to extract power from near-field communication signals; a power input terminal configured to receive an input supply voltage; and a power output terminal configured to provide an output power signal. In an embodiment, the rectifier comprises a rectifying bridge. In an embodiment, the power input terminal is configured to couple to a battery. In an embodiment, the power output terminal is configured to couple to a battery charger. In an embodiment, the near-field communication circuitry is configured to generate one or more power-output control signals. In an embodiment, the one or more power-output control signals comprise a switch-control signal. In an embodiment, the integrated circuit comprises a terminal configured to output the switch-control signal. In an embodiment, the integrated circuit comprises a switch coupled between the rectifier and the power output terminal and configured to receive the switch-control signal. In an embodiment, the one or more power-output control signals comprise a variable-resistance control signal. In an embodiment, the integrated circuit comprising a terminal configured to output the variable-resistance control signal. In an embodiment, the near-field communication circuitry is configured to generate the one or more power-output control signals based on when near-field transactions occur.

In an embodiment, a system comprises: a battery configured to provide power to the system; a battery charger configured to charge the battery; a near-field communication circuit; and a connection configured to provide power from the near-field communication circuit to the battery charger. In an embodiment, the near-field communication circuit comprises a rectifying bridge having an output directly connected to a terminal of said near-field communication circuit. In an embodiment, the connection comprises a switch configured to selectively couple the near-field communication circuit to the battery charger. In an embodiment, said switch is controlled by the near-field communication circuit. In an embodiment, the connection comprises a resistive element. In an embodiment, said resistive element is of a variable type and the near-field communication circuit is configured to control a value of the resistive element. In an embodiment, the system comprises mobile communication circuitry.

In an embodiment, a method comprises: communicatively coupling a mobile communication device having near-field communication circuitry to a near-field communication terminal; and controlling a connection between the near-field communication circuitry of the mobile communication device and a battery charger of the mobile communication device based on communications between the near-field communication circuitry and the near-field communication terminal. In an embodiment, controlling the connection comprises enabling a transfer of power from the near-field communication circuitry to the battery charger over the connection outside of a period of a transaction between the near-field communication circuitry and the near-field communication terminal. In an embodiment, controlling the connection comprises controlling a switch configured to couple the near-field communication circuitry to the battery charger. In an embodiment, controlling the connection comprises controlling a resistance of a variable resistor.

In an embodiment, a mobile communication device comprises: means for supplying power to the system; means for charging the means for supplying power; means for processing near-field communications; and means for selectively enabling a transfer of power from the means for processing near-field communications to the means for charging. In an embodiment, the mobile communication device comprises means for processing mobile communication signals. In an embodiment, the mobile communication device comprises an integrated circuit including at least part of the means for processing near-field communications and at least part of the means for selectively enabling.

The foregoing and other features and advantages will be discussed in detail in the following non-limiting description of example embodiments in connection with the accompanying drawings.

### BRIEF DESCRIPTION OF THE SEVERAL VIEWS OF THE DRAWINGS

FIG. 1 is a simplified representation of a near-field communication system and of an embodiment of a mobile device;

FIG. 2 is a simplified block diagram illustrating an embodiment of a battery recharge system;

FIG. 3 shows an embodiment of the system of FIG. 2; and

FIG. 4 illustrates a variation of FIG. 3.

### DETAILED DESCRIPTION

In the following description, numerous specific details are given to provide a thorough understanding of embodiments. The embodiments can be practiced without one or more of the specific details, or with other methods, components, materials, etc. In other instances, well-known structures, materials, or operations, such as, for example, near field communication devices, rectifiers, processors, memories, etc., are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” “according to an embodiment” or “in an embodiment” and similar phrases in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of embodiments.

For clarity, only those steps and elements which are useful to the understanding of the present disclosure have been shown and will be described. In particular, the near-field communication mechanisms have not been detailed, the described embodiments being compatible with usual communication mechanisms. Further, the components of the mobile device other than those useful to the understanding of the described embodiments have not been detailed, since they are here again compatible with the elements currently equipping a mobile device provided with an NFC router.

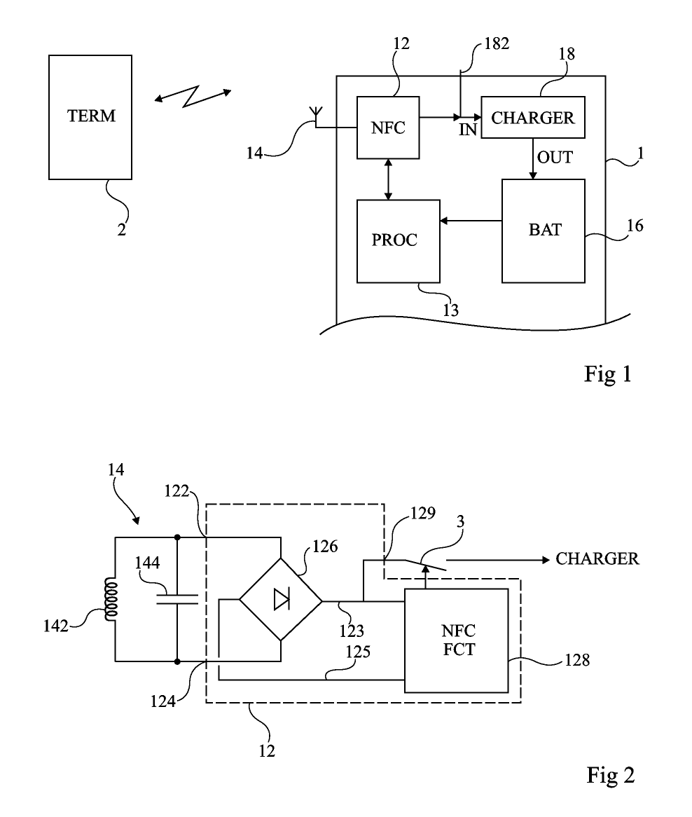

FIG. 1 is a simplified representation in the form of blocks of a near-field communication system partially illustrating an embodiment of a mobile device equipped with a battery and a near-field communication unit.

Device 1 comprises, among others, a near-field communication interface 12 (NFC) connected to an antenna 14 to communicate with a terminal 2 (TERM) when device 1 is at a small distance from the terminal. Device 1 further comprises a battery 16 for operating this device independently from the near-field communication mode. For example, in the case of a mobile phone, battery 16 enables to operate the phone for the GSM-type telecommunication. Battery 16 is charged by means of a charger 18 (CHARGER) equipping device 1 and generally receiving a D.C. voltage from a terminal 182 intended to be connected to an external transformer. Battery charger 18 generally is a voltage regulation system enabling to provide battery 16 with an adapted charge voltage and to control the battery charge.

Device 1 further comprises various processing circuits according to its nature. Such circuits have been symbolized in FIG. 1 by a block 13 (PROC). These circuits are typically capable of being powered by battery 16 and, at least for some of these, of communicating with NFC router 12 in order to draw the power necessary to their operation from the high-frequency field radiated by terminal 2 and detected by antenna 14, in card mode. Block 13 may comprise, for example, one or more processors, one or more memories, discrete circuitry, etc., and various combinations thereof.

According to the shown embodiment, the NFC router is further used to recharge the battery.

The present inventors have indeed observed that, during near-field communications, the NFC router remains within the range of the terminal for a duration generally longer than the duration necessary for the transaction which is based on this communication. The described embodiments then provide taking advantage of at least this additional duration to use the power and thus charge the battery.

It used to be believed that the short durations during which a mobile device is within the range of a terminal did not justify to be concerned by the battery charge and it used to be only focused on the use of the power detected from the terminal field to operate the device in near field and possible charge a storage element of, for example, a capacitor type for the duration of the communication.

The present inventors here consider that a succession of short charge periods may however be profitable to the optimization of the system power.

FIG. 2 is a partial simplified diagram of an embodiment of an NFC router 12. This router comprises two terminals 122 and 124 having antenna circuit 14 connected thereto. This circuit is electrically formed of a parallel oscillating circuit formed of an inductive element 142 forming the antenna and of a capacitive element 144 in parallel (or in series). In certain cases, element 144 is integrated to router 12. Terminals 122 and 124 are generally connected to the input of a rectifying bridge 126 having its outputs 123 and 125 powering the functions in near field (block 128 NFC FCT). Functions 128 generally are the radio frequency coding and decoding elements as well as the different NFC processing circuits.

In the shown embodiment, output terminal 123 of the rectifying bridge is connected to a terminal 129 of circuit 12 (NFC) to be connected, for example, by a switch 3, to charger 18 and more specifically to its input terminal IN (See FIG. 1). In the embodiment of FIG. 2, switch 3 is controlled by NFC circuit 128 to be preferentially turned on outside periods when a near-field transaction is taking place between the terminal and the router. Thus, the use of the near-field communication power is optimized while reducing the possibility of adversely affecting the quality of the transaction.

To simplify the representation, only the connection to the positive potential of bridge 126 has been illustrated. Of course, the ground of charger 18 (and of the battery) may be common with the bridge ground (125).

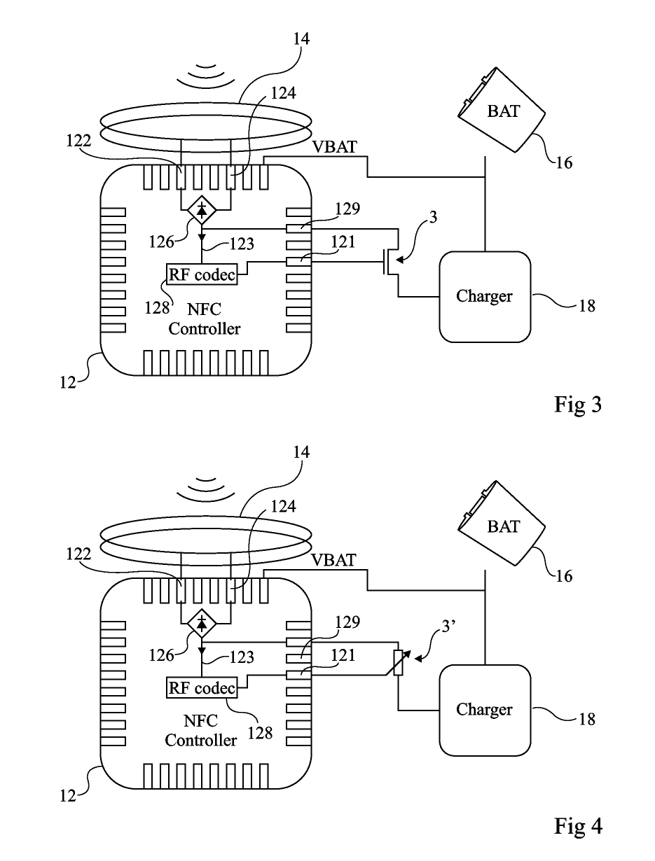

FIG. 3 schematically illustrates an example of an architecture respecting the embodiment of FIG. 2. Circuit 12 is generally made in the form of an NFC controller in a single integrated circuit which contains rectifying bridge 126. This embodiment takes advantage of the presence of terminals available in such an integrated circuit, such as terminal 129 and of a terminal 121 for controlling switch 3.

FIG. 4 illustrates another embodiment which differs from that of FIG. 3 in that switch 3 is replaced with a resistive element of variable value 3′ having its level controlled by circuit 12. The use of a resistor enables to limit the effects of the charge on the radio communication. The fact of making the resistance optionally variable enables to adapt its value according to whether the transaction is taking place or not.

Various embodiments have been described, various alterations, modifications, and improvements will occur to those skilled in the art. In particular, the practical implementation of the control of the switch or of the resistor outside near-field transactions is within the abilities of those skilled in the art based on the functional description given hereabove and by using the functions currently present in the NFC routers.

Some embodiments may take the form of computer program products. For example, according to one embodiment there is provided a computer readable medium comprising a computer program adapted to perform one or more of the methods described above. The medium may be a physical storage medium such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the systems and/or modules may be implemented or provided in other manners, such as at least partially in firmware and/or hardware, including, but not limited to, one or more application-specific integrated circuits (ASICs), discrete circuitry, standard integrated circuits, controllers (e.g., by executing appropriate instructions, and including microcontrollers and/or embedded controllers), field-programmable gate arrays (FPGAs), state machines, complex programmable logic devices (CPLDs), etc., as well as devices that employ RFID technology. In some embodiments, some of the modules or controllers separately described herein may be combined, split into further modules and/or split and recombined in various manners.

The systems, modules and data structures may also be transmitted as generated data signals (e.g., as part of a carrier wave) on a variety of computer-readable transmission mediums, including wireless-based and wired/cable-based mediums.

The various embodiments described above can be combined to provide further embodiments. Aspects of the embodiments can be modified, if necessary to employ concepts of the various patents, applications and publications to provide yet further embodiments.

Such alterations, modifications, and improvements are intended to be part of this disclosure, and are intended to be within the spirit and the scope of the present disclosure. Accordingly, the foregoing description is by way of example only and is not intended to be limiting.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An integrated circuit, comprising:
near-field communication circuitry configured to process near-field communication signals;
a rectifier configured to extract power from near-field communication signals;
a power input terminal configured to receive an input supply voltage; and
a power output terminal configured to provide an output power signal.

2. The integrated circuit of claim 1 wherein the rectifier comprises a rectifying bridge.

3. The integrated circuit of claim 1 wherein the power input terminal is configured to couple to a battery.

4. The integrated circuit of claim 1 wherein the power output terminal is configured to couple to a battery charger.

5. The integrated circuit of claim 1 wherein the near-field communication circuitry is configured to generate one or more power-output control signals.

6. The integrated circuit of claim 5 wherein the one or more power-output control signals comprise a switch-control signal.

7. The integrated circuit of claim 6, further comprising a terminal configured to output the switch-control signal.

8. The integrated circuit of claim 6, comprising a switch coupled between the rectifier and the power output terminal and configured to receive the switch-control signal.

9. The integrated circuit of claim 5 wherein the one or more power-output control signals comprise a variable-resistance control signal.

10. The integrated circuit of claim 9, further comprising a terminal configured to output the variable-resistance control signal.

11. The integrated circuit of claim 5 wherein the near-field communication circuitry is configured to generate the one or more power-output control signals based on when near-field transactions occur.

12. A system, comprising:
a battery configured to provide power to the system;
a battery charger configured to charge the battery;
a near-field communication circuit; and
a connection configured to provide power from the near-field communication circuit to the battery charger.

13. The system of claim 12 wherein the near-field communication circuit comprises a rectifying bridge having an output directly connected to a terminal of said near-field communication circuit.

14. The system of claim 12 wherein the connection comprises a switch configured to selectively couple the near-field communication circuit to the battery charger.

15. The system of claim 14 wherein said switch is controlled by the near-field communication circuit.

16. The system of claim 12 wherein the connection comprises a resistive element.

17. The system of claim 16 wherein said resistive element is of a variable type and the near-field communication circuit is configured to control a value of the resistive element.

18. The system of claim 12, further comprising mobile communication circuitry.

19. A method, comprising:
communicatively coupling a mobile communication device having near-field communication circuitry to a near-field communication terminal; and
controlling a connection between the near-field communication circuitry of the mobile communication device and a battery charger of the mobile communication device based on communications between the near-field communication circuitry and the near-field communication terminal.

20. The method of claim 19 wherein the controlling the connection comprises enabling a transfer of power from the near-field communication circuitry to the battery charger over the connection outside of a period of a transaction between the near-field communication circuitry and the near-field communication terminal.

21. The method of claim 19 wherein the controlling the connection comprises controlling a switch configured to couple the near-field communication circuitry to the battery charger.

22. The method of claim 19 wherein the controlling the connection comprises controlling a resistance of a variable resistor.

23. A mobile communication device, comprising:
means for supplying power to the system;
means for charging the means for supplying power;
means for processing near-field communications; and
means for selectively enabling a transfer of power from the means for processing near-field communications to the means for charging.

24. The mobile communication device of claim 23, further comprising means for processing mobile communication signals.

25. The mobile communication device of claim 23, comprising an integrated circuit including at least part of the means for processing near-field communications and at least part of the means for selectively enabling.
